(19) United States
(12) Patent Application Publication
(10) Pub. No.: US 2015/0367522 A1
(43) Pub. Date: Dec. 24, 2015

(54) RAZOR DEVICE

(71) Applicant: Charisse MARTIN, Brooklyn, NY (US)

(72) Inventor: Charisse MARTIN, Brooklyn, NY (US)

(21) Appl. No.: 14/313,320

(22) Filed: Jun. 24, 2014

(51) Int. Cl. B26B 21/52; B26B 21/06; B26B 21/40

(52) U.S. Cl. CPC B26B 21/527; B26B 21/4081; B26B 21/06

(57) ABSTRACT

A razor device may include a finger attachment component comprising a shell. An attachment mechanism may connect to the shell. A razor component having a body and at least one blade attached to the body may attach to the side of the shell of the finger attachment component. The device may further include a fastener disposed along a first end of the attachment component. The device may allow a user to shave with better control, more safety, and a shorter amount of time versus a standard razor. The razor device may be used for hard to reach areas, such as the vaginal area.

### BACKGROUND OF THE INVENTION

The present invention relates to razors and, more particularly, to a razor device for hard to reach areas.

Hard to reach areas, such as the vaginal area, are difficult areas to shave, especially the outer labia because it is a sensitive. The area is hard to reach with a regular shaped and sized razor. Shaving the vaginal area is time consuming, specifically the outer labia. The outer labia is small and sensitive, so it is not advised to apply pressure similar to the pressure you would apply shaving any other part of your body. Pressure applied to this area may cause a tremendous amount of damage.

As can be seen, there is a need for a razor device that provides a more effective, less time consuming shave for hard to reach areas, such as the vaginal area.

### SUMMARY OF THE INVENTION

In one aspect of the present invention, a razor device comprises: a finger attachment component comprising a shell and an attachment mechanism, wherein the attachment mechanism connects to the shell; and a razor component having a body and at least one blade attached to the body, wherein the razor component is attached to a side of the shell of the finger attachment component.

In another aspect of the present invention, a method for shaving a vaginal area comprises the steps of: placing a razor device on the end of a finger, the razor device including a finger attachment component comprising a shell and an attachment mechanism, wherein the attachment mechanism connects to the shell; and a razor component having a body and at least one blade attached to the body, wherein the razor component is attached to a side of the shell of the finger attachment component; removably securing the razor device in place on the finger; and shaving the vaginal area with the at least one blade of the razor device.

These and other features, aspects and advantages of the present invention will become better understood with reference to the following drawings, description and claims.

### BRIEF DESCRIPTION OF THE DRAWINGS

FIG. 1 is a side perspective view of an exemplary embodiment of the present invention shown in use;

FIG. 2 is an exploded side elevation view of an exemplary embodiment of the present invention;

FIG. 3 is a bottom plan view of an exemplary embodiment of the present invention; and

FIG. 4 is a front elevation view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a razor device that may include a finger attachment component comprising a shell. An attachment mechanism may connect to the shell. A razor component having a body and at least one blade attached to the body may attach to the side of the shell of the finger attachment component. The device may further include a fastener disposed along a first end of the attachment component. The device may allow a user to shave with better control, more safety, and a shorter amount of time versus a standard razor. The razor device may be used for hard to reach areas, such as the vaginal area.

The present invention may allow for an easier shave of hard to reach areas, such as, but not limited to, the vaginal area. With no handle required, the user may be able to access the area and be able to shave areas that may be out of reach with a typical razor with handle. Additional pubic hair may be removed by the current device over a typical razor in a shorter amount of time and with greater safety.

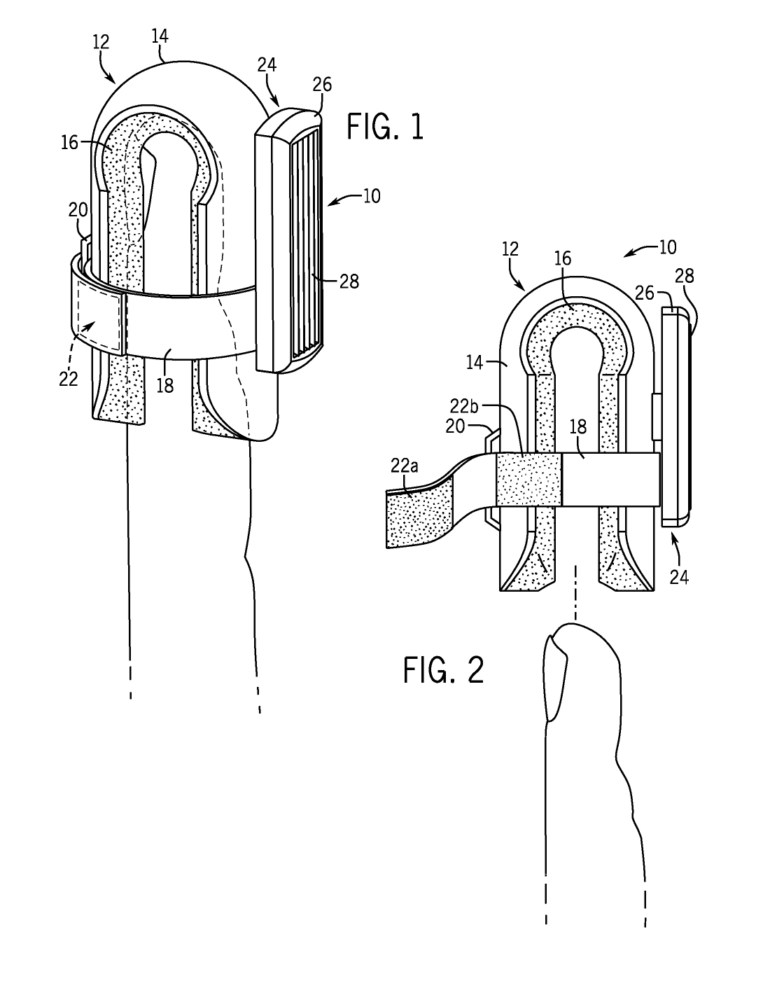

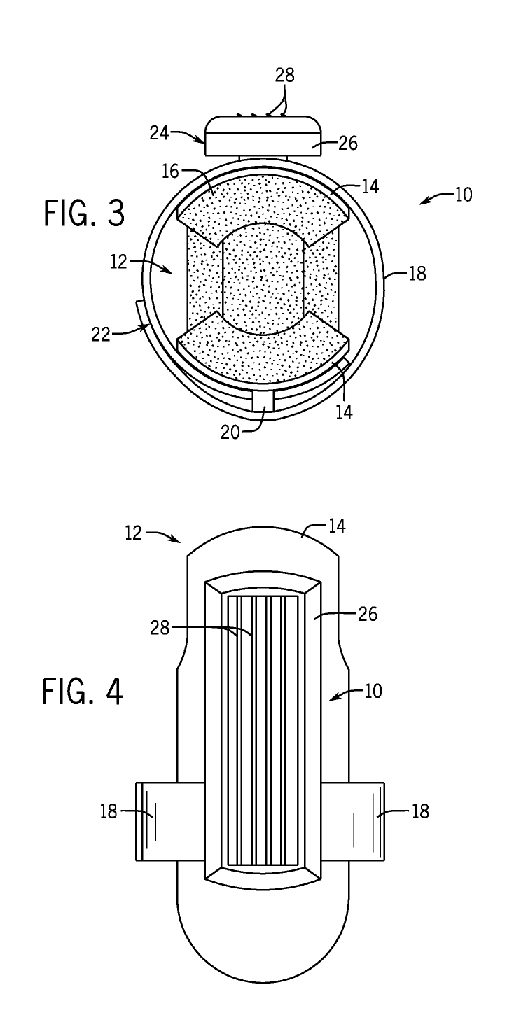

As is illustrated in FIGS. 1 through 4, a razor device 10 may include a finger attachment component 12 and a razor component 24. In certain embodiments, the finger attachment component 12 may include a shell 14, a cushion component 16, and an attachment mechanism 18. The cushion component 16 may partially surround an end of a finger of a user. The cushion component 16 may be foam or the like. In certain embodiments, the shell 14 may cover the cushion component 16. The attachment mechanism 18 may be attached to the shell 14 disposed along a side proximate a bale 20. In certain embodiments, the attachment mechanism 18 may be attached to an outside surface of the shell 14. The attachment mechanism 18 may be a strap or the like. The attachment mechanism 18 may removably secure the finger attachment component 12 to the finger of the user. A fastener 22 may be disposed along a first end of the attachment mechanism 18. The fastener 22 may be a hook and loop fastener with a hook portion 22a and a loop portion 22b, or the like, to removably secure the attachment component 12 in place. In certain embodiments, the attachment component 12 may be adjustable for the size of the finger, the tightness around the finger, or the like.

The razor component 24 may include a body 26 and at least one blade 28. The razor component 24 may be attached to the side of the finger attachment component 12. In certain embodiments, the razor component 24 may attach to the shell 14 of the finger attachment component 12. In certain embodiments, the razor component 24 may be positioned in line with the finger attachment component 12 with the at least one blade 28 approximately perpendicular to the finger. In certain embodiments, the razor component 24 may be disposable.

A method of using the razor device 10 may include the following. A user may place the razor device 10 on the end of their finger. The razor device 10 may partially surround the end of the finger. In certain embodiments, the attachment mechanism may removably secure the razor device 10 in place on the finger. In other embodiments, the fastener 22 may removably secure the razor device 10 to the finger. The at least one blade 28 of the razor component 24 may be facing outward from the finger. The user may then use the razor device 10 to shave bodily hair. With the compact size of the razor device 10, the user may have more control and better access to areas that are usually hard to access.

It should be understood, of course, that the foregoing relates to exemplary embodiments of the invention and that modifications may be made without departing from the spirit and scope of the invention as set forth in the following claims.

What is claimed is:

1. A razor device comprising:
a finger attachment component comprising a shell and an attachment mechanism, wherein the attachment mechanism connects to the shell; and
a razor component having a body and at least one blade attached to the body, wherein the razor component is attached to a side of the shell of the finger attachment component.

2. The razor device of claim 1, wherein the finger attachment component further comprises a cushion component, wherein the shell covers the cushion component.

3. The razor device of claim 2, wherein the cushion component is made of foam.

4. The razor device of claim 1, wherein the finger attachment component is removably secured in place by a fastener disposed along a first end of the attachment mechanism.

5. The razor device of claim 1, wherein the attachment mechanism is a strap.

6. A method for shaving a vaginal area comprising the steps of:
placing a razor device on the end of a finger, the razor device comprising a finger attachment component comprising a shell and an attachment mechanism, wherein the attachment mechanism connects to the shell; and a razor component having a body and at least one blade attached to the body, wherein the razor component is attached to a side of the shell of the finger attachment component;
removably securing the razor device in place on the finger; and
shaving the vaginal area with the at least one blade of the razor device.

7. The method of claim 6, wherein the finger attachment component further comprises a cushion component, wherein the shell covers the cushion component.

8. The method of claim 7, wherein the cushion component is made of foam.

9. The method of claim 6, wherein the finger attachment component is removably secured in place by a fastener disposed along a first end of the attachment mechanism.

10. The method of claim 6, wherein the attachment mechanism is a strap.
